(19) United States
(12) Patent Application Publication
(10) Pub. No.: US 2017/0046492 A1
(43) Pub. Date: Feb. 16, 2017

(54) DECISION TREE DATA PROCESSING SYSTEM

(71) Applicant: CoverMyMeds LLC, Columbus, OH (US)

(72) Inventors: Daniel W. Renner, Pickerington, OH (US); Matthew A. Scantland, Columbus, OH (US); Alan J. Gilbert, Sunbury, OH (US); Michael P. Gee, Groveport, OH (US); Graham D. Conzett, Columbus, OH (US); Jon P. Canady, Columbus, OH (US); Patricia A. Yacovone-Biagi, Worthington, OH (US); Julie M. Hessick, Hilliard, OH (US); Samuel M. Rajan, Hudson, OH (US); Nicholas J. Seguin, Columbus, OH (US)

(21) Appl. No.: 15/233,725

(22) Filed: Aug. 10, 2016

Related U.S. Application Data
(60) Provisional application No. 62/205,579, filed on Aug. 14, 2015.
(60) Provisional application No. 62/253,390, filed on Nov. 10, 2015.

(51) Int. Cl. G06F 19/00; G06N 7/00

(52) U.S. Cl. CPC G06F 19/345; G06F 19/322; G06N 7/005

(57) ABSTRACT

A decision tree processing system comprises non-transitory data storage configured to store a target data stream and a hardware processor in communication with the non-transitory data storage. The hardware processor can be programmed to access the target data stream, apply a decision tree to at least a portion of the target data stream, and generate a predicted outcome based at least partly on the applied decision tree. The decision tree can comprise a question set that is applied to the target data stream to generate a set of answers that are used at least partly to generate the predicted outcome. In various implementations, the decision tree processing system can be applied to geographic information services, prescription medication prior authorizations, or the Internet of Things.

### CROSS-REFERENCE TO RELATED APPLICATIONS

This application claims the benefit of priority under 35 U.S.C. §119(e) to U.S. Patent Application No. 62/205,579, filed Aug. 14, 2015 and to U.S. Patent Application No. 62/253,390, filed Nov. 10, 2015, each of which is hereby incorporated by reference herein in its entirety for all it discloses.

### BACKGROUND

Field

The disclosure is related to artificial intelligence systems, and in particular to systems using decision tree processing to provide a predetermination of a likely decision about a target property based on a set of rules and a target data set.

Description of the Related Art

Artificial intelligence systems can use machine learning techniques to analyze a data set and predict an outcome. An example of a machine learning technique is decision tree learning which can map observations about attributes of a target to a decision about a test value or property associated with the target. Decision trees can include rules about the target and can make classifications or predictions based on these rules as applied to the target.

### SUMMARY

An embodiment of a decision tree processing system comprises non-transitory data storage configured to store a target data stream and a hardware processor in communication with the non-transitory data storage. The hardware processor can be programmed to access the target data stream, apply a decision tree to at least a portion of the target data stream, and generate a predicted outcome based at least partly on the applied decision tree. The decision tree can comprise a question set that is applied to the target data stream to generate a set of answers that are used at least partly to generate the predicted outcome. In an implementation, the target data stream comprises traffic or accident information, and the predicted outcome comprises a predicted route that avoids the traffic or the accident. In another implementation, the target data stream comprises prescription medication information, and the predicted outcome comprises a predetermination of whether a prior authorization for the prescription medication will be required by a health plan. In another implementation, the target data stream comprises sensor data communicated from a plurality of sensors that measure a parameter (e.g., household temperature) that is reflective of an electric load, and the predicted outcome comprises predicted electric power usage patterns.

The foregoing summary is intended to illustrate example embodiments and not to limit the scope of the disclosure.

### BRIEF DESCRIPTION OF THE DRAWINGS

FIG. 1 is a block diagram that schematically illustrates an example of a decision tree processing system.

FIG. 2 is a block diagram that schematically illustrates an example of an electronic prior authorization (ePA) process for obtaining real-time (or near real-time) approval of an ePA request.

FIG. 3 is a flowchart that schematically illustrates an example of a method for making a predetermination of a prior authentication request using a machine learning technique such as decision tree processing.

FIG. 4 schematically illustrates an example of a system for processing electronic prior authorization requests for prescription medications.

FIG. 5 is a flowchart that schematically illustrates another example of a method for making a predetermination of a prior authentication request using a machine learning technique such as decision tree processing.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

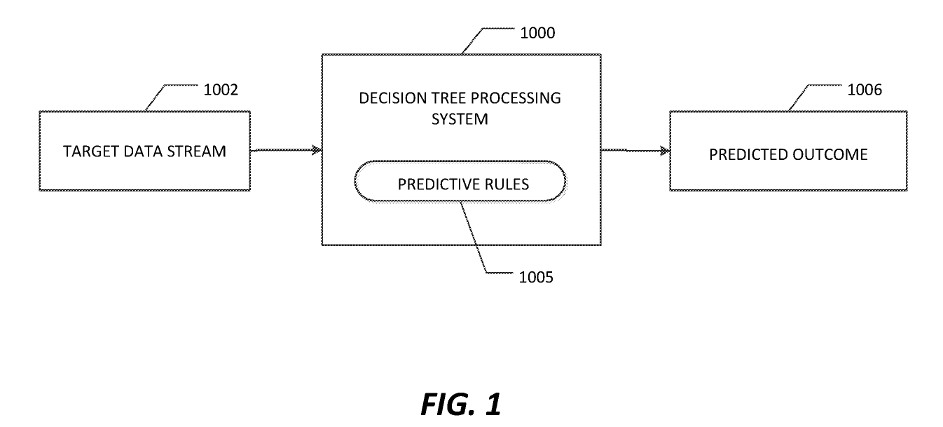

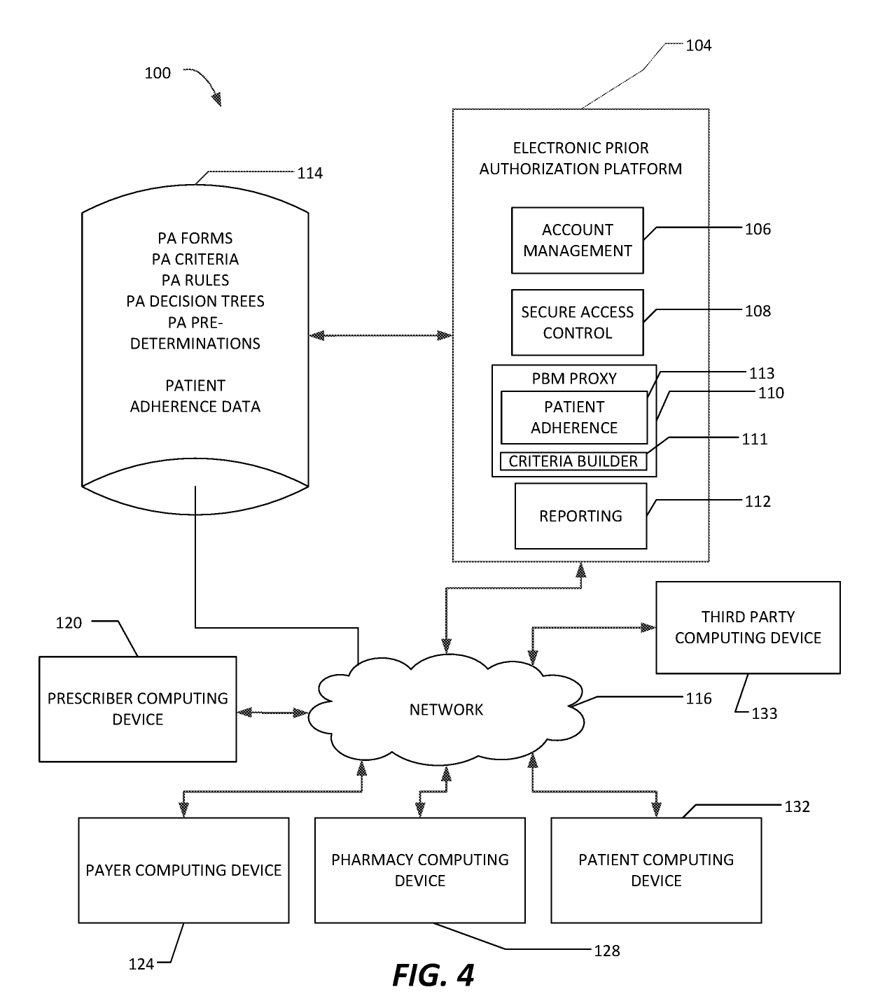

FIG. 1 is a block diagram that schematically illustrates an example of a decision tree processing system 1000. The decision tree processing system 1000 includes a set of predictive rules 1005 that are applied to a target data stream 1002 in order to provide a predicted outcome 1006. The decision tree processing system 1000 can comprise a network-connected hardware computing system, with non-transitory data storage configured to store the predictive rules 1005, at least a portion of the target data stream 1002, and the predicted outcome 1006. For example, the system 1000 can be connected to a network 116 described with reference to FIG. 4 to receive the target data stream 1002 and to provide the predicted outcome 1006. The predictive rules 1005 can be in the form of a decision tree comprising a plurality of nodes. For example, a decision node can specify a test that is carried out on an attribute value (included in the target data stream) and can branch into one or more sub-trees for each possible outcome of the test. A leaf node can indicate the value of a target attribute. The decision tree is applied to the target data stream 1002 and the nodes are traversed until the predicted outcome 1006 is reached.

As an example relating to a geographic information service (GIS), the target data stream may include data from sensors that monitor traffic flow and accidents on roadways. The decision tree processing system 1000 can analyze the traffic flow and accident data and apply the predictive rules 1005 to predict the best routes among the roadways or to predict routes that bypass congested areas or accidents.

As an example relating to the Internet of Things (IoT), the target data stream 1002 can data from temperature sensors (e.g., thermostats) in homes, and the decision tree processing system 1000 can extract temperature data from the network stream and apply the predictive rules to the temperature data to predict where electric power will be needed in an electric power grid as well as to predict other electric power usage patterns. Such analysis by the decision tree processing system may be particularly advantageous in hot summer months to help prevent electrical power shortages or outages.

As yet another example (which will be described in more detail below), the target data stream 1002 can include data relating to prescriptions for medications received from health insurance provider computers and/or pharmacy computers. The decision tree processing system 1000 can apply the predictive rules 1005 to this data stream to predict a likelihood that a health insurance provider will require a prior authorization for the prescription medication. Further details of examples of decision tree processing for making a predetermination of whether a prior authorization for a prescription medication will be described below.

The foregoing are examples intended to illustrate different applications of the system 1000 and are not intended to be limiting. Additional details on some of these applications will be provided below.

### Overview of Prior Authorization

The cost of prescription medications may be covered by a health insurance plan. At least a portion of the costs of prescription medications covered by the health insurance plan may be paid on behalf of the patient by the health insurance provider. Other prescription medications falling outside of the coverage of a health insurance plan must be paid for, in full, out of pocket by the patient or other recipient of such prescription medications.

Whether a prescription drug is or is not covered by a health insurance plan is not always readily determinable. For example, certain dosages or concentrations of a prescription drug may be covered, while others are not. Likewise, a prescription drug covered as an accepted treatment for a first medical condition may not be covered to treat a different medical condition, because it may be uncertain whether the prescription drug constitutes an effective treatment for that different medical condition. A prescription for a drug with a generic equivalent available may also be covered, but only if there is a reason why the generic equivalent is unsuitable.

Commonly, a physician lacks precise information about what medications the patient's insurance carrier might cover and when, given that the physician may deal with multiple insurance carriers, each with a variety of different plans. Also, insurance carriers' formularies (which list medications covered under the insurance plan) frequently change, so that even if a physician had some kind of formulary reference, there is a strong possibility of its being out of date. Physicians are usually forced to write a prescription and hope for the best outcome for the patient under the patient's policy.

A patient may report back later that, according to the pharmacist, their insurance requires prior authorization (PA) for that drug before covering it. The physician can then attempt to write a different prescription and try again, or enter into the time-consuming process of obtaining prior authorization for the drug. Often, patients receiving such responses from pharmacists simply elect to abandon the prescription, with adverse health effects.

When it is unknown whether insurance coverage for a prescription drug is available, a request for prior authorization (PA) to fulfill a prescription for a drug under the coverage of a health insurance plan can be submitted to the health insurance plan. The request for PA may be a form (paper or electronic) with a number of information fields (e.g., patient and physician information, insurance plan information, drug information, etc.) to be completed by the pharmacy and/or prescribing physician. Each health insurance provider may have its own individual form for a particular drug and/or particular insurance plan. In one example of submitting such a request, the pharmacy fulfilling the drug prescription can enter the information pertaining to the patient, drug and health insurance plan into an appropriate form. The at-least-partially-completed PA request form can be transmitted to the physician who prescribed the drug and/or the patient in order to be completed before being submitted to the health insurance provider or a pharmacy benefits manager (sometimes also referred to as a payer). The payer can then make a determination as to whether the patient's insurance plan provides at least some coverage for the prescribed drug and provide payment to appropriate parties.

Many prior authorization decisions, however, are sufficiently complicated that the insurer must follow up with the physician for more detailed information, e.g., what other drugs the physician had already prescribed for the patient's treatment, whether passive therapy had been attempted and for how long, whether the patient had shown an adverse reaction to certain other drugs, and so forth. This can become a cumbersome back-and-forth dialogue between the physician and the insurer before a decision on the prior authorization request is made.

Traditionally, requests for prior authorization took the form of paper forms which a physician (or staff) filled out and faxed to the insurer. Electronic prior authorization requests (ePA) can be submitted over a network connection to an insurer, e.g., via the ePA platform described below. The National Council for Prescription Drug Programs (NCPDP, Scottsdale, Ariz.), a non-profit standards body, has created a standard for electronic prior authorization requests.

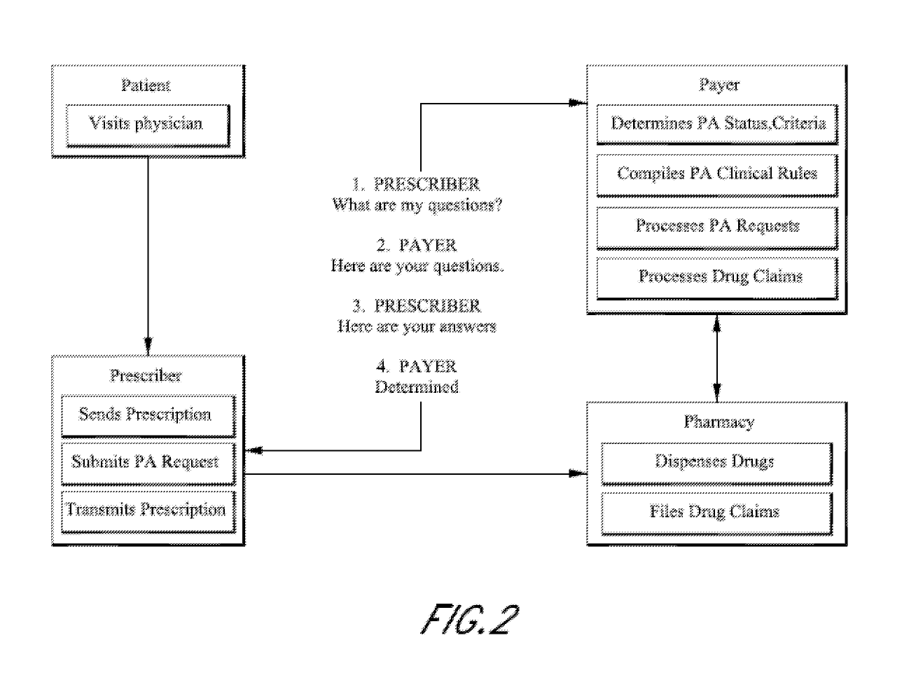

FIG. 2 is a block diagram that schematically illustrates an example of an ePA process for obtaining real-time (or near real-time) approval of an ePA. The example ePA process can utilize patient-specific and drug-specific PA criteria (e.g., as established by the payer). The example ePA process shown in FIG. 2 involves a four-part transaction that enables patient-specific and drug-specific PA criteria and a real-time approval process. In this example, a patient visits a prescriber (e.g., the patient's physician) who prescribes a medication and electronically transmits a prescription request (ePrescription) to a pharmacy and an ePA to a payer (such as the patient's health insurer). The pharmacy can dispense the prescribed medication to the patient and file a medication reimbursement claim. The payer processes the ePA and drug claims requests and establishes the criteria and clinical rules for the PA process for the prescription medication. The prescriber and the payer typically exchange questions (from the payer, based on the PA criteria and clinical rules) and answers (from the prescriber, based on the medical history of the patient) until a decision by the payer is made on whether to approve or reject the PA request for the prescribed drug. As will be further discussed below, payers may require information on patient adherence to a treatment regimen before the PA request for a medication can be approved. In such cases, patient adherence data (e.g., laboratory test results) may be used to determine a likelihood that the patient is indeed adhering to the treatment regimen, and this likelihood may be factored into the PA approval process.

Electronic prior authorization platforms can make the ePA request form accessible from within a user account associated with the prescribing physician. For example, the prescribing physician may access the PA platform via a network (such as the Internet) using a graphical user interface (e.g., a web browser or dedicated application). Examples of computerized methods and apparatus for accessing, completing, and processing electronic prior authorization requests for prescription medications are described in U.S. Patent Application Publication No. 2011/0257992 to Scantland et al., which is hereby incorporated by reference herein in its entirety for all it discloses (hereinafter referred to as the '992 Publication).

A prescribing physician or other authorized party affiliated with the physician (e.g., the physician's office staff) will generally be hereinafter referred to generically as the “prescriber” for the sake of brevity. Further, the term physician can include a medical doctor (MD), a doctor of osteopathic medicine (DO), a physician assistant (PA), an optometrist (DO), a podiatrist (DPM), a dentist (DDS or DDM), a veterinarian (DVM), an advanced practice medical nurse (APRN), a clinical pharmacist, a medical or nurse practitioner, a medical psychologist, or any other person authorized or licensed to prescribe medications. The term medication includes drugs, medicines, pharmaceuticals, medicaments, medicinal products, medical devices or appliances, or any other substance, device, or apparatus having properties for treating or preventing disease in humans or animals.

### Example Criteria Builder Workflow

An ePA system (such as, e.g., any of the systems described in the '992 Publication or embodiments of the system 100 described with reference to FIG. 4) can include functionality for speeding up the ePA determination process by reducing the back-and-forth between the prescriber and payer described above. The ePA system can provide a workflow process that accesses locally stored data on a payer's PA criteria and PA rules in order to provide the relevant PA questions to the prescriber, accept the prescriber's responses, and prepare and submit the appropriate ePA form to the payer. Since the ePA is likely to include answers to the questions the payer needs to accept the ePA request, the ePA can in many cases be processed in (near) real-time so that the prescriber can promptly receive a decision on the PA request.

The following is a non-limiting, illustrative example of the workflow that the ePA system can establish with the prescriber. In some of the examples described herein, the computing functionality that performs the workflow process is referred to as Criteria Builder. Some of the workflow will be described with reference to FIG. 2.

The prescriber initiates an ePA on the ePA system by, for example, accessing a user interface (UI) on a computing device (e.g., an application which allows the prescriber computing device to communicate with the ePA system). In an embodiment, the prescriber can select a button on the UI (e.g., “Send to Plan”) to submit the at least partially completed ePA for processing. As will be discussed, the destination where the ePA is transmitted for processing will depend on whether the payer participates in the Criteria Builder program provided by the ePA system. With reference to FIG. 2, the prescriber is asking the payer “What are my questions?”—e.g., what information does the payer want to know from the prescriber in order to determine whether it should approve the PA request and remit payment?

The UI on the prescriber computing device can be associated with the prescriber's electronic health record system or e-prescription system. In some cases, the UI is provided by the ePA system (e.g., as a web application). The UI advantageously may implement the NCPDP ePA standard for increased compatibility with ePA systems, which also implement the NCPDP standard. The prescriber can have an authenticated account on the ePA system.

If the payer does not participate in the Criteria Builder program, the ePA is transmitted by the ePA system to the payer for the payer to process in the conventional fashion. The payer may communicate a list of questions appropriate for the patient's insurance plan and prescribed medication. The prescriber can respond by submitting answers to the questions to the payer via the UI. As discussed above, this can lead to a back-and-forth between the prescriber and the payer as the payer's questions are answered by the prescriber. This can disadvantageously lead to inefficiencies and delays in the processing and approval of the ePA request.

If the payer advantageously participates in the Criteria Builder program, the ePA is not transmitted to the payer. Instead, the ePA is transmitted by the ePA system to a payer simulation application (“PBM Proxy”) associated with the ePA system. This non-conventional practice permits the ePA system to more expeditiously interact with the prescriber and improve the processing time for the ePA. The PBM Proxy can be a part of the ePA system or a separate or remote application or system (e.g., connected to the ePA system via a network connection).

The PBM Proxy receives the ePA request (which may, but need not, conform to the NCPDP standard) similar to how the patient's payer would receive the ePA request. The PBM Proxy determines whether the patient is eligible (e.g., is actually covered under the payer's plan). In various implementations, the PBM Proxy makes this determination by transmitting a request to the payer's eligibility determination service (and, in response, receiving an eligibility determination by the payer for the patient) or through a module internal to (or in communication with) the PBM Proxy that also evaluates patient eligibility based (at least in part) on the payer's eligibility rules. The module can include computer executable software instructions and can be stored in a memory.

If the PBM Proxy determines that the ePA is for a covered (eligible) patient, the PBM Proxy then sends a request to an application, Criteria Builder, which returns a list of questions appropriate for the patient's PA for this payer, the patient's insurance plan, and prescribed medication. Criteria Builder can be a separate or remote application (from the PBM Proxy) or internal to the PBM Proxy. With reference to FIG. 2, the payer is telling the prescriber “Here are your questions”—e.g., here is the information that the payer wants to know from the prescriber in order to determine whether the payer should approve the PA request and remit payment.

In many cases, the list of questions is in the form of a decision tree that presents a tree-like model of questions and possible answers leading to a conclusion or decision (e.g., PA request approved or rejected). The decision tree may start from a root node and proceed through one or more internal decision nodes (with two or more branches) to reach a leaf node that represents a decision, conclusion, or classification. The decision nodes may represent binary questions (e.g., yes-no or true-false) or may represent more complicated questions (e.g., which age range is the patient in: 10-20 years, 21-30 years, 31-40 years . . . ). With reference to the decision tree processing system 1000 of FIG. 1, the predictive rules 1005 can include these questions and answers, and the predicted outcome 1006 can correspond to a predetermination of whether a PA will be required for the prescription medication.

The PBM Proxy transmits the list of questions to the prescriber computing system for presentation to the prescriber (e.g., via the UI). The list of questions may be in accordance with the NCPDP ePA standard, as if the prescriber were interacting with the patient's payer (rather than the PBM Proxy). The prescriber fills out answers to the returned questions (e.g., via entering information on an electronic form via the UI) and submits the answers to the ePA system. With reference to FIG. 1, the prescriber is telling the payer “Here are your answers”—e.g., here is the information you wanted to know in order to determine whether to approve the PA request and remit payment.

The PBM Proxy receives the answer set (from the prescriber computing device) and passes the answer set to Criteria Builder. In some embodiments, Criteria Builder stores not merely the bare question sets from a payer, but also their expected and/or acceptable answer keys. Criteria Builder can take the answers received from the prescriber and “walk” through the payer's decision tree, similarly as the payer's staff would.

The following is an example of a partial list of questions that could be presented to the prescriber via the UI of the prescriber's computing device. The prescriber computing device receives the list of questions from the ePA system (e.g., from the PBM Proxy). The following is a portion of a decision tree presented to the prescriber and includes the prescriber's answers. Note that in this example, the decision tree may be able to return a decision regarding the PA request (e.g., DENIED) before the end of the tree is reached. In other examples, additional or different questions can be asked.

Q1. Is the patient male? If yes, go on to Question 2. If no, go on to Question 33.

A1: YES.

Q2: Is the patient over the age of 55? If yes, go on to Question 3. If no, return DENIED.

A2: YES

Q3. What condition is this prescription intended to treat? If within ICD-9 Codes 524.60-524.69, go on to Question 4. If ICD-9 Code 719.40, go on to Question 17. Otherwise, return DENIED.

A3: 524.64

Q4. Has the patient had this condition for at least 6 months? If yes, go on to Question 5. If no, return DENIED.

A4: NO

After traversing the decision tree, Criteria Builder returns to PBM Proxy a recommended claim determination, e.g., what the payer's decision probably would be according to its own company standards. With reference to FIG. 2, the ePA system with PBM Proxy and Criteria Builder uses the questions and answers to make a predetermination of the likely decision by the payer—“Determined”, e.g., the PA accepted or PA denied.

The PBM Proxy transmits the prescriber's ePA, together with the recommended claim determination (from the decision tree), to the payer. The payer computing system receives such a “predetermined” ePA, optionally including the entire question-answer decision-making history. Depending upon its own internal processes, the payer can either defer to Criteria Builder's existing determination of whether to accept or reject the PA and promptly transmit a final pay/deny determination, have internal staff perform a double-check of all determinations, set aside “complicated” cases for close examination, review only a statistical sample for quality control, or take other actions. Accordingly, the predetermination of the PA request by the ePA system can advantageously improve the subsequent workflow by the payer and lead to more rapid decisions on the PA request.

The ePA system transmits to the prescriber a prompt electronic response from the payer regarding the prescriber's request for prior authorization. From the perspective of the prescriber, the prescriber need not (but may) know whether the prescriber is answering questions from the payer or from Criteria Builder. The question and answer process is transparent to the prescriber and does not require the prescriber to learn how to use new software.

### Example Advantages of Certain Criteria Builder Implementations

The ePA system including Criteria Builder accelerates the PA determination process by transparently interposing itself in the transaction, applying the payer's specific PA standards for the prescribed medication and patient plan, and sending the transaction to the payer in a “pre-approved/pre-denied” state, to simplify the payer's subsequent processing of the PA request. This pre-approval (or pre-denial) is done according to the payer's own specified standards, so the payer can have a high level of confidence that these outcomes are correct, and save the payer's staff's research and analysis effort for marginal or poorly-documented cases, or those where Criteria Builder has passed along some kind of predetermination result that the prescriber's answers do not provide sufficient information for a decision to be made. The PA predetermination process also further speeds up ePA determination turnaround, especially in straightforward cases where the outcome is relatively easy to determine (based on the question-and-answer responses) and should be sent to the prescriber right away without waiting for a human being to review the PA request. An additional advantage of some implementations is that the question and answer listing can be provided in the existing NCPDP ePA standard and hence the ePA request is portable and compatible with any system that adopts the NCPDP standards.

In addition, the decision tree traversal results can be more informative than a simple yes/no outcome, which may be useful to the payer. For example, the ePA system may process the questions and answers and provide information such as the following to the payer: “The recommended outcome is DENIAL because of the prescriber's answer at Step 2. However, even if the tree had passed Step 2, it would nevertheless have been DENIAL because of the prescriber's answer at Step 11. Prescribers' answers at Step 2 can sometimes be ambiguous or confusing, but the reviewer should be aware that the outcome would have been the same anyway.”

In some implementations, information processed by the ePA system can be transmitted to the prescriber. For example, “This ePA is probably going to be DENIED because of your “no” answer at Step 3. Please be advised that if your answer to Step 3 were “yes”, and if your answer to Step 11 were “more than three months”, Standard Insurance probably would approve this ePA.” The prescriber can modify the ePA request (if desired) and re-submit the ePA, which may result in a more favorable determination for the patient.

### Facsimile (Fax) PA Requests

Additionally or alternatively, having the payer's question set stored in a data repository accessible by Criteria Builder allows the ePA system to, once a prescriber has created an ePA answering the questions, create a faxed paper PA equivalent (e.g., automatically rendering the analogous paper form into an electronic format with all the answers in all the appropriate boxes). This means that the prescriber can have the benefits of creating an ePA (filling out online a dynamically generated question set of only the necessary questions for a PA determination) even if the payer typically will not necessarily accept ePAs or if the payer's ePA acceptance system is not currently functioning. For example, the PBM Proxy can pass the answers on to a form rendering engine (which may render portable document format (PDF) forms), which then electronically faxes the electronically rendered equivalent of the appropriate paper form. The PBM Proxy can ignore the pre-determination and tree-traversing functionality to permit the prescriber to create the PA request via fax.

### Example Criteria Builder Method

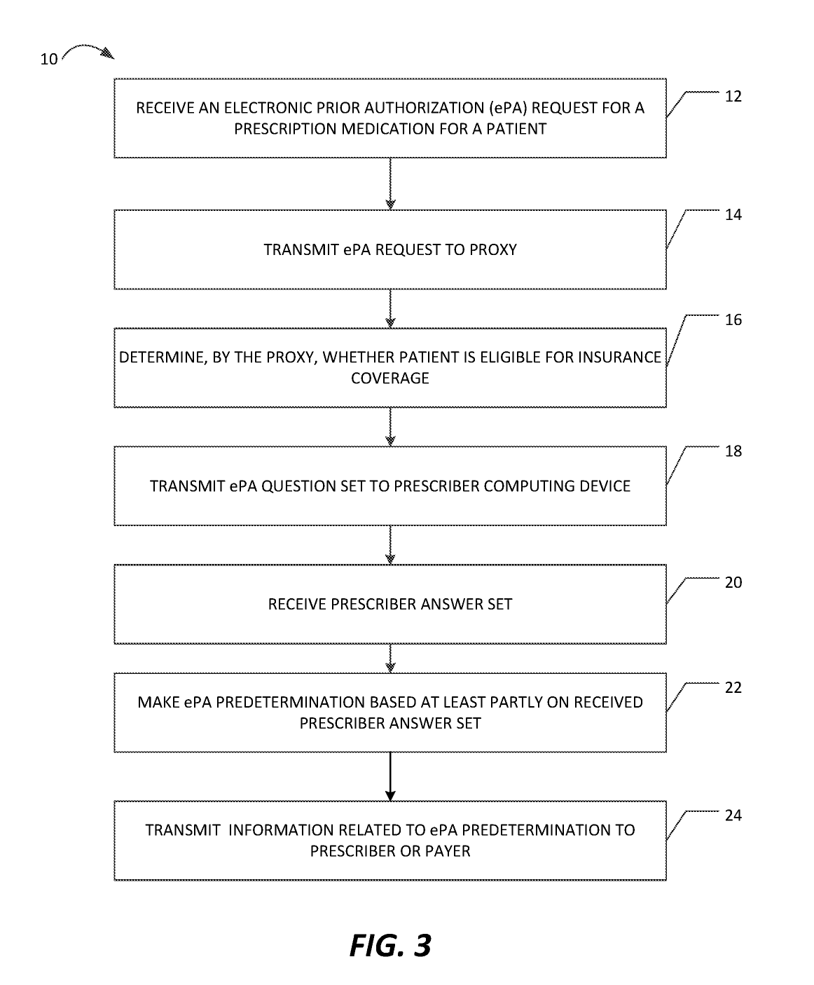

FIG. 3 is a flowchart that schematically illustrates an example of a method 10 for making a predetermination of a prior authentication request. The method 10 can be performed by the decision tree processing system 1000 described with reference to FIG. 1, the system 100 described with reference to FIG. 4, or systems similar to those described in the '992 Publication. The example method 10 is intended to illustrate features of the method but is not intended to be limiting.

At block 12, the method 10 receives an ePA request for a prescription medication from the prescriber's computing device. For example, the prescriber may have an authorized account on the ePA system. At block 14, the method 10 determines if the payer participates in the Criteria Builder program, and if so, the ePA request is transmitted to a proxy system that acts in the place of the payer's system. The proxy system can be implemented by computing hardware. At block 16, the proxy determines whether the patient is eligible for coverage by the payer for the prescription medication. As discussed above, the proxy may transmit a request to the payer's eligibility determination service (and, in response, receive an eligibility determination by the payer for the patient) or the proxy may use an eligibility rules database for the payer to evaluate patient eligibility. If the patient is not eligible for coverage, the ePA request can be denied by the proxy and the denial communicated back to the prescriber computing device.

If the patient is eligible for coverage by the payer, at block 18 an ePA question set is transmitted to the prescriber computing device. A UI or app on the prescriber computing device can permit the prescriber to enter responses to the question set and the prescriber computing device can transmit the prescriber answer set to the proxy. At block 20, the prescriber answer set is received, e.g., by the proxy. At block 22, the method 10 evaluates the prescriber answer set in view of an expected and/or acceptable answer key for the payer. Depending on the prescriber responses in the answer set, the method 10 can make a predetermination of whether the ePA request is likely to be approved or denied by the payer.

At block 24, information related to the predetermination is transmitted to the prescriber, the payer, or both the prescriber and the payer. For example, information transmitted to the payer may, optionally, include the entire question-answer decision-making history (e.g., the question set and the prescriber answer set). Depending upon its own internal processes, the payer can either defer to the predetermination of whether to accept or reject the ePA made by the method 10 and promptly transmit (or confirm) a final pay/deny determination, have internal payer staff perform a double-check of all determinations, set aside “complicated” cases for close examination, review only a statistical sample for quality control, or take other actions. The information relating to the ePA can be transmitted to the prescriber, for example, whether the ePA is approved or denied. The information may include alternatives. For example, the information can include a cheaper (e.g., generic) alternative to an approved brand-name medication, information on why the ePA was denied, information on what needs to be changed in the ePA in order for the payer to approve the ePA, and so forth. Further, in some embodiments, the method 10 may communicate the decision on the ePA request to a pharmacy for fulfillment and dispensing of the medication to the patient.

### Example Criteria Builder System

FIG. 4 schematically illustrates an example of a system 100 for processing electronic prior authorization requests for prescription medications. The system 100 can implement the Criteria Builder functionality described herein. The system 100 can perform embodiments of the method 10 described with reference to FIG. 3, or any of the other functionality described herein. The electronic prior authorization platform 104 can include embodiments of the decision tree processing system 1000 described with reference to FIG. 1. In some implementations, the Criteria Builder system 111 described below includes the decision tree processing system 1000.

In some implementations, the system 100 transmits the ePA questions sets to the prescribers, receives the prescriber answer set, and makes a predetermination for the ePA. The system 100 can implement the PA techniques described in the '992 Publication. The system 100 includes an electronic prior authorization platform 104 configured to communicate over a network 116 with one or more computing devices such as a prescriber computing device 120, a payer computing device 124, a pharmacy computing device 128, or a patient computing device 132. The system 100 can communicate with non-transitory data storage 114 that stores the PA electronic forms, PA criteria and PA rules for the various payers, PA question sets and answer keys (e.g., as decision trees). The ePA platform 104 can receive the ePA requests from the prescriber computing device 120.

As will be further discussed herein, in certain implementations, the ePA platform 104 can include various systems including an account management system 106, a secure access control system 108, a PBM proxy system 110, and a reporting system 112. The ePA platform 104 may be maintained by, or on behalf of an insurance provider or by a third-party intermediary that is independent of health insurance providers.

The ePA platform 104 can be implemented on computer hardware, such as one or more physical computer servers programmed with specific computer-executable instructions. The computing devices 120-132 can include general purpose computers, servers, data input devices (e.g., terminals or displays), web interfaces, portable or mobile computers, laptops, or tablets, smart phones, etc. The computing devices 120-132 can include user interfaces to allow users to communicate with the ePA platform 104 over the network 116. The computing devices 120-132 can additionally or alternatively include software applications that can communicate with the ePA platform, for example by using a suitable Application Program Interface (API). The network 116 can provide wired or wireless communication between the computing devices 120-132 and the ePA platform 104 or the data storage 114. The network 116 can be configured as a local area network (LAN), a wide area network (WAN), the Internet, an intranet, combinations of the same, or the like. In certain embodiments, the network 116 can be configured to support secure shell (SSH) tunneling or other secure protocol connections for the transfer of data between the ePA platform 104 and the computing devices 120-132 or the data storage 114.

The ePA platform 104 includes the account management system 106 that can handle creation and maintenance of user accounts on the platform. For example, a prescriber can access the ePA platform via a user interface on the prescriber computing device 120 to request an account. The prescriber computing device 120 may operate an electronic health records system (including an e-prescription system) that facilitates interaction with the platform 104. The prescriber may be asked to provide publicly-available information that can include, for example, the prescriber's name, address, telephone number, facsimile (fax) number, electronic mail (email) address, and so forth. The prescriber can also be identified based at least in part on a prescriber identification token that is uniquely associated with the prescriber. For example, the prescriber identification token can include the physician's National Provider Identifier (NPI), which is a unique 10-digit identification number issued to health care providers in the United States by the Centers for Medicare and Medicaid Services as mandated by HIPAA. Information such as the NPI is commonly included with a prescription for the medication prescribed by the prescriber.

The account management system 106 may associate the account with the prescriber identification token so that the account can be uniquely identified. The prescriber may be able to access the account by utilizing a user interface that allows the prescriber to enter the prescriber identification token (e.g., the prescriber's NPI) and a password. The secure access control system 108 can be configured to verify that a party attempting to create an account on the platform 104 is actually the prescriber and not an impersonator. The secure access control system 108 can also provide security to prevent unauthorized access to or disclosure of the ePA requests, payer decision trees and PA criteria and rules stored in the data storage 114.

The ePA platform 104 can facilitate the process of obtaining a PA for a prescription medication and/or facilitate the process for determining whether the patient will need a PA for the prescription medication and whether a PA is likely to be approved or denied by a payer. For example, the ePA platform 104 can access the data storage 114 and transmit the appropriate payer's question set to the prescriber computing device 120 for completion by the prescriber, and receive the prescriber's answer set from the prescriber computing device. The ePA platform can compare the prescriber answer set to an answer key accessed from the data storage 114 and make a predetermination whether the payer is likely to approve or deny the ePA. The ePA platform can store the prescriber answer set in the storage 114.

The PBM proxy system 110 can perform at least portions of the disclosed methods for predetermining an ePA. For example, the PBM proxy system 110 can receive the ePA request and determine patient eligibility for coverage under a payer's plan. As discussed, the PBM proxy system 110 may transmit a request to the payer's eligibility determination service via the network 116 (and, in response, receive an eligibility determination by the payer for the patient) or the proxy system may use an eligibility rules database (e.g., accessed from the data storage 114) to evaluate patient eligibility. If the patient is not eligible for coverage, the ePA request can be denied by the proxy and the denial communicated back to the prescriber computing device 120.

The PBM proxy system can include a Criteria Builder system 111 that implements the functionality for communicating payer question sets to the prescriber computing device 120, receiving prescriber answer sets from the prescriber computing device, comparing the prescriber answer set to a payer answer key, and making a predetermination of whether the payer is likely to approve or deny the ePA request. In the example system 100, the Criteria Builder system 111 is a component of the PBM proxy system 110, however, in other implementations, the Criteria Builder system 111 can be separate from the PBM proxy system.

The user can input information into the system 100 (e.g., via text entry fields in a PA form, a user interface, etc.). In some cases, the platform 104 may auto-populate one or more fields on the form or user interface. The form (or information entered into such forms) can be transmitted over the communication network 116. For example, a pharmacist may begin entry of information into the form or user interface but needs additional information from the prescriber (or the patient) to complete the prescription or PA request before it is sent to the insurance provider. The platform 104 can communicate the form (or the appropriate information) to the prescriber or patient for completion.

The prescriber can access the partially-completed PA form by logging in to the prescriber's account on the platform 104. The prescriber can complete the remaining required fields on the form, electronically sign the form, and submit the form to the health insurance provider via the platform 104. The prescriber can complete the PA question set (e.g., via responding to the questions in the payer decision tree for the prescribed medication) and submit the answer set to the ePA system via the platform 104.

If the payer is not enrolled in the Criteria Builder program, the ePA platform 104 can transmit the ePA form to the payer computing device 124 so that the payer can determine whether to approve, deny, cancel, or request additional information for the form. The payer can be an insurance company, a pharmacy benefits manager (PBM), an administrator of a prescription drug program, or other entity responsible or authorized to process and/or pay prescription medication claims.

If the payer is enrolled in the Criteria Builder program, the ePA platform 104 can transmit the ePA form to the PBM proxy system 110 so that the criteria builder system 111 can make a predetermination of whether the payer is likely to approve, deny, cancel, or request additional information for the ePA request.

The platform 104 can include the reporting system 112, which can perform various administrative functions for the system 100. For example, the reporting system 112 can perform reporting, auditing, logging, and other communication functions with managers, administrators, and users of the system 100. For example, the reporting system 112 can store a copy of the prescription, the PA request form (or the information used to populate the prescription or form), the question set and prescriber answer set, and so forth. The reporting system 112 may also log (or store a log of) successful transactions or communications between, for example, a pharmacist and a prescriber and the prescriber. The reporting system 112 can transmit information related to the ePA predetermination to the prescriber computing device 120 and/or the payer computing device 124.

### Example Systems and Methods for Patient Adherence for Prescription Medications

Prescription medications vary wildly in cost, with the most expensive costing tens of thousands of dollars per month. In such cases, the ability of a payer to make accurate coverage determinations is advantageous to avoid financial waste or to ensure that scarce or perishable medications are provided to patients who are likely to enjoy successful treatment outcomes. For expensive medications, a payer may, for instance, require prior authorization for continued treatment not on an annual or quarterly basis, but more frequently such as on a monthly, weekly, or daily basis.

One possible solution for payers to ensure successful treatment outcomes is to require mandatory treatment adherence, e.g., that continued authorization of treatment is contingent upon the patient following a particular regimen. This regimen may include having the patient take the medication at every prescribed interval, as well as having the patient meet one or more other PA conditions. For example, the payer may require the patient to refrain from use of certain foods, beverages, or medications (e.g., refrain from drinking alcoholic beverages), take certain foods, beverages, or medications along with the prescribed medication (e.g., take the medication following a meal), meet certain medical standards, conditions, or tests (e.g., evidence a reduction in blood cholesterol or a blood protein), or other objectively verifiable indicators.

Unfortunately, the payer has no direct way of verifying that the patient is actually adhering to his or her treatment adherence program. One possible approach is for the patient to conduct frequent follow-up examinations with the prescriber (or a provider representative), who can then attempt to verify adherence and answer questions about patient adherence when submitting subsequent ePAs for the medication. However, this is expensive (as the payer must now likely cover the additional prescriber or provider visits) and time-consuming for patients and prescribers or providers. In addition, it is possible that the prescribers or providers may receive inaccurate information from patients, or report inaccurate answers in subsequent ePAs.

The example system 100 illustrated in FIG. 4 can include features to assist with avoiding one or more challenges with patient adherence to a prescription medication regimen.

For example, the system 100 can optionally receive patient adherence data from third party computing devices 133 via the network 116 and store the patient adherence data in the data storage 114. Third parties can include drug testing labs, prescribers, representatives of the health care provider, social workers, home health care professionals, representatives of state disability boards, etc. The patient adherence data can include objective clinical evidence that the patient is adhering to the prescription medication regime. The system 100 can include a patient adherence system 113 that can associate ePAs with the patient adherence data, while “in transit” to the Criteria Builder system 111. In some implementations, the system 100 thereby provides an “enriched” ePA, which is an ePA with the additional patient adherence data associated with (e.g., attached to or included or combined with) the ePA. For example, when the patient's prescriber submits an initial or renewal ePA for the prescribed medication, embodiments of the system 100 can detect that patient adherence data is required by the health insurance provider for the prescribed medication (or, at least, beneficially should be submitted with the ePA to facilitate approval) in order to perform an adjudication (e.g., by the Criteria Builder 111) of whether the ePA is likely to be approved. For example, the PBM proxy system 110 can receive the ePA request and determine that patient adherence data is required (or advantageous) for coverage of the prescription medication under a payer's plan or based on the requirements of a payer's prescription medication formulary.

In some embodiments, the patient adherence system 113 can place the ePA into a “hold” state (sometimes referred to as a “pause” state, and can be provided by, e.g., utilizing functionality within the general NCPDP ePA standard to do so), pending receipt of the third-party patient adherence data. The system 100 then optionally notifies the third-party data provider 133 to communicate relevant laboratory results to the system 100. For example, the system 100 may notify the third party to log in to a special and secure website to enter or upload lab results (for storage by the data storage 114). In some cases, the system 100 can provide an initial notification to the third party that patient adherence data is needed on an ongoing (e.g., periodic, weekly, etc.) basis, and the third party (via the third party computing device 133 and the network 116) can continue to provide the patient adherence data according to a schedule appropriate to the patient's treatment regimen. This third-party patient adherence data (received by the system 100) can then be associated with the ePA, which is then released from the hold or pause, and permitted to pass onward into the Criteria Builder system 111 for adjudication or sent to the health insurance provider for an adjudication.

In some embodiments, the Criteria Builder system 111 can track patient adherence data over time. For example, Criteria Builder can be configured to compare a first patient adherence data at a first time (e.g., this week's drug test) to a second patient adherence data for a second time (e.g., last week's drug test), and to identify any trends or correlations in the data. For example, the Criteria Builder system 111 may identify a downward trend in a quantity measured from the patient (e.g., a downward trend in the concentration of the prescribed medication in the patient's blood), which may indicate patient non-compliance (or partial compliance with the prescription regimen). Criteria Builder can communicate a notification to appropriate providers (e.g., the prescriber, the health insurance provider, a patient support center for the prescribed medication (e.g., “hub”)) regarding a level of patient compliance with the treatment regimen. The provider can take an appropriate action to improve patient compliance (e.g., a concierge at the hub may call the patient on the telephone and make sure there are no changes in the patient's condition that inhibit compliance with the prescribed treatment regimen).

Example Patient Adherence Workflow

An illustrative, non-limiting example of a workflow for incorporating patient adherence data into an ePA is now presented. In this example, Patient A has XYZ Syndrome. Doctor B has previously tried Patient A on various therapies and alternative medications, without significant improvement. Doctor B now believes that Placebin, an expensive, just-approved drug may be effective for Patient A's illness. Patient A's insurer, General Insurance, is reluctant to cover Placebin unless medical necessity can be demonstrated, and the treatment will only be effective if Patient A is certain to take every dose. Doctor B writes Patient A a prescription for Placebin, and submits an initial ePA to General Insurance, documenting Patient A's need for Placebin. General Insurance issues an initial coverage determination agreeing to pay for Patient A's Placebin, but only for two weeks of medication. Subsequent fills will require renewed ePAs to show Patient A's compliance with taking every dose of the prescribed medication.

Continuing with this example, every two weeks, Doctor B submits a renewal ePA for Placebin. The system 100 pauses the ePA. Patient A undergoes testing at a third-party testing laboratory. The laboratory logs into a secure laboratory portal and uploads Patient A's test results. The laboratory portal may be a secure website, an ftp site, an electronic fax number that provides access to the data storage 114. The laboratory portal may be provided by the ePA Platform 104 or by another party. In another example, the laboratory submits Patient A's test results to the prescriber for review, and the prescriber communicates the test results to the data storage 114.

The system 100 can attach or include the test results with the ePA, and release the ePA (with test results) from the hold state for adjudication. In various cases, the adjudication can be performed by the Criteria Builder system 111 or by transmitting the ePA directly to General Insurance. If the test results show that Patient A is likely adhering to the prescribed treatment regimen, General Insurance is able to make a coverage determination with significantly greater confidence that covering Placebin for Patient A will lead to a positive outcome and is financially justified. In the case that the test results demonstrate that Patient A may not have been adhering to the treatment regimen, the Criteria Builder system 111 may issue an adjudication that the ePA is unlikely to be approved (or communicate the ePA and test results to the insurer).

Continuing with the example list of questions discussed above, the list could include the following question for the prescriber (and is an example of a portion of a decision tree or predictive rules):

“Q2: Is the patient regularly taking his prescribed dose of the prescribed medication?

A2: YES”

Additionally or alternatively, the list of questions can include inquiries regarding the patient adherence data, with the answers provided by an automated determination by the Patient Adherence system 113 based at least partly on the patient adherence data stored in the storage 114, e.g.:

“Q2: Is a concentration of Placebin greater than 35 ppm present in the patient's urine, indicating regular use?”

A2: 44 ppm—YES″.

The ability to determine, from the patient adherence data, answers to particular inquiries regarding patient compliance can improve the likelihood of a positive adjudication of the patient's ePA for the medication (which facilitates future patient compliance because the patient is able to continue to receive the medication) as well as providing quantitative assurance to the health insurance provider that continued payment for the medication is providing patient health benefits and is financially justified.

Various embodiments of the system 100 may provide one or more advantages. As one example, many states impose firm deadlines on how long payers can take to evaluate and approve or deny an ePA. An insurer may or may not be able to await independent lab testing results, because state regulations might force the insurer to make a determination before those results came in. The fact that some embodiments of the system 100 can pause an ePA in transit, associate third-party patient adherence data with the ePA, and then transmit it “enriched” on to the payer or to the Criteria Builder system 111, increases the likelihood that the payer never receives an ePA that it does not have enough information to properly evaluate. The ability of payers to make timely, informed decisions can be considerably increased.

It should also be noted that the third-party source from which information can be drawn need not be a testing laboratory. The patient's primary care physician, specialist physicians, home health workers, social workers, or even state disability determination agencies could singly or jointly be sources of adherence or other treatment outcome information (for instance, a payer could be willing to continue to cover antipsychotic medication only if the patient's caseworker continues to certify that the patient is actually known to her to be taking the medication).

### Example Criteria Builder Method Including Patient Adherence

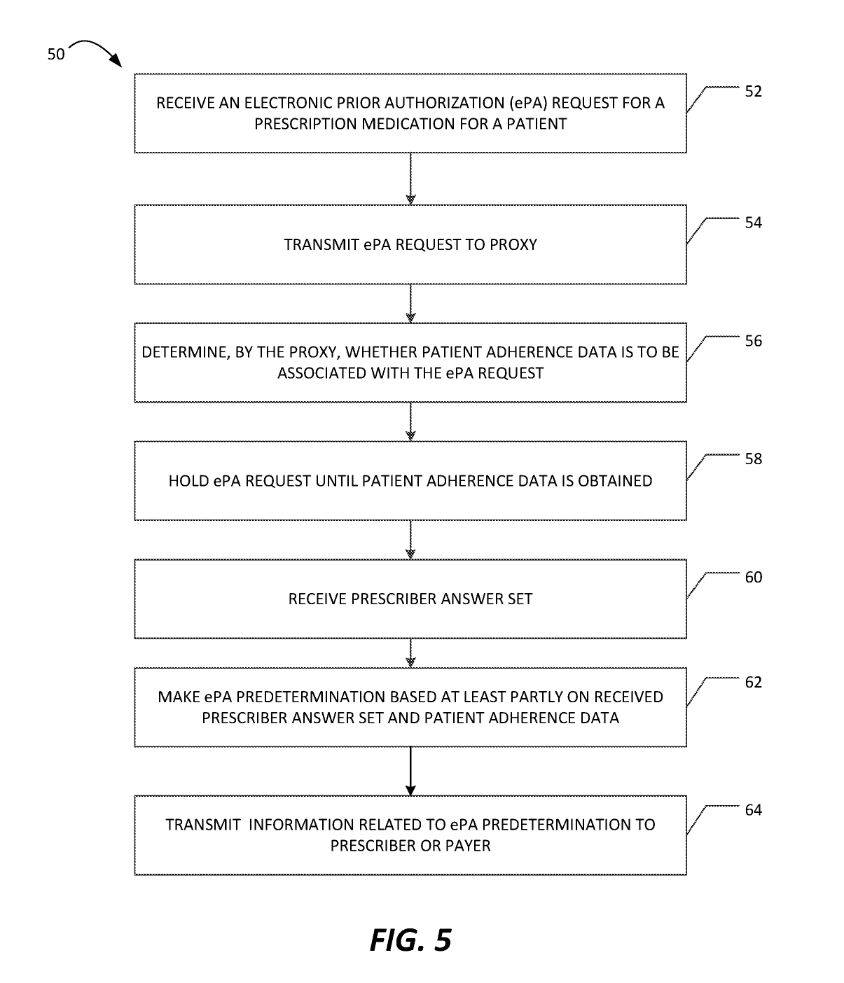

FIG. 5 is a flowchart that schematically illustrates an example of a method 50 for making a predetermination of a prior authentication request. The method 50 can be performed by the system 100 described with reference to FIG. 4 (or embodiments of the decision tree processing system 1000). The example method 50 is intended to illustrate features of the method but is not intended to be limiting. The method 50 is generally similar to the method 10 described with reference to FIG. 3 but includes methodology to utilize patient adherence data in the ePA process.

At block 52, the method 50 receives an ePA request for a prescription medication from the prescriber's computing device. For example, the prescriber may have an authorized account on the ePA system. At block 54, the method 50 determines if the payer participates in the Criteria Builder program, and if so, the ePA request is transmitted to a proxy system that acts in the place of the payer's system. The proxy system can be implemented by computing hardware (e.g., the ePA platform 104). The proxy determines whether the patient is eligible for coverage by the payer for the prescription medication. As discussed above, the proxy may transmit a request to the payer's eligibility determination service (and, in response, receive an eligibility determination by the payer for the patient) or the proxy may use an eligibility rules database for the payer to evaluate patient eligibility. If the patient is not eligible for coverage, the ePA request can be denied by the proxy and the denial communicated back to the prescriber computing device.

If the patient is eligible for coverage by the payer, at block 56 the method 50 determines whether the prescribed medication is one for which patient adherence data will be required (or at least advantageous) by the health provider. For example, the method 50 may consult a formulary or a health insurance plan's guidelines to determine whether to obtain patient adherence data. The method may transmit an ePA question set to the prescriber computing device. The question set may include questions about patient adherence to a treatment regimen associated with the prescribed medication. A UI or app on the prescriber computing device can permit the prescriber to enter responses to the question set and the prescriber computing device can transmit the prescriber answer set to the proxy. If patient adherence data is not needed, the method 50 can move to block 60 as described below.

If patient adherence data is to be obtained, at block 58 the method 50 can place a hold on the ePA request until the patient adherence data is obtained. As described above, the method 50 may notify a third party (e.g., a testing lab) that test results are needed, and the hold will continue until the third party provides the test results (e.g., by uploading the test results to the data storage 114). After the patient adherence data is obtained, the method 50 can release the hold, and the method 50 can move to block 60.

At block 60, the prescriber answer set is received, e.g., by the proxy. At block 62, the method 50 evaluates the prescriber answer set in view of an expected and/or acceptable answer key for the payer. The method 50 also evaluates the patient adherence data (e.g., in view of payer requirements for the patient's treatment regimen) to determine a likelihood that the patient is complying with the treatment regimen. Depending on the prescriber responses in the answer set and the evaluation of the patient adherence data, the method 50 can make a predetermination of whether the ePA request is likely to be approved or denied by the payer.

At block 64, information related to the predetermination is transmitted to the prescriber, the payer, or both the prescriber and the payer. For example, information transmitted to the payer may, optionally, include the entire question-answer decision-making history (e.g., the question set and the prescriber answer set) or the relevant answers (e.g., based at least partly on the patient adherence data) to inquiries about patient adherence. Depending upon its own internal processes, the payer can either defer to the predetermination of whether to accept or reject the ePA made by the method 50 and promptly transmit (or confirm) a final pay/deny determination, have internal payer staff perform a double-check of all determinations, set aside “complicated” cases for close examination, review only a statistical sample for quality control, or take other actions. The information relating to the ePA can be transmitted to the prescriber, for example, whether the ePA is approved or denied. The information may include alternatives. For example, the information can include a cheaper (e.g., generic) alternative to an approved brand-name medication, information on why the ePA was denied, information on what needs to be changed in the ePA in order for the payer to approve the ePA, information on what steps the patient should take to ensure compliance with the treatment regimen, and so forth. Further, in some embodiments, the method 50 may communicate the decision on the ePA request to a pharmacy for fulfillment and dispensing of the medication to the patient.

### Additional Information

All of the processes and process steps described above (including those of FIGS. 3 and 5) may be embodied in, and fully automated via, software code modules executed by one or more general purpose computers or computing devices programmed with specific computer-executable instructions. The code modules or the resulting data or output from the processes may be stored in any type of non-transitory computer-readable medium or other computer storage or storage device. As mentioned above, some or all of the methods or steps may alternatively be embodied in specialized computer hardware. The results of the disclosed methods and tasks may be persistently stored by transforming physical storage devices, such as solid state memory chips and/or magnetic disks, into a different state.

Thus, all of the methods and tasks described herein may be performed and fully automated by a programmed or specially configured computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other computer-readable storage medium.

Code modules may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed processes and process steps (or any data accessed or used) may be stored, persistently or otherwise, in any type of non-transitory, tangible computer storage or may be communicated via a computer-readable transmission medium.

Any processes, blocks, states, steps, or functionalities in methods or flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer or software product or packaged into multiple computer or software products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network (e.g., a terrestrial and/or satellite network) or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

Further, certain implementations of the functionality of the present disclosure are sufficiently mathematically, computationally, or technically complex that application-specific hardware or one or more physical computing devices (utilizing appropriate specialized executable instructions) may be necessary to perform the functionality, for example, due to the volume or complexity of the calculations involved or to provide results substantially in real-time. For example, the large number of possible prescription medications, the large number of payers, and the large volume of ePA requests that flow through the ePA system typically require specifically programmed computer hardware to be necessary to process the data to process the ePA requests in a commercially reasonable amount of time or to provide ePA predeterminations in (near) real-time.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” or “an” or “the” as used in this application and any appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing description is intended to illustrate, and not limit, the inventive subject matter. The scope of protection is defined by the claims. In the following claims, any reference characters are provided for convenience of description only, and not to imply that the associated steps must be performed in a particular order.

What is claimed is:

1. A decision tree processing system comprising:
non-transitory data storage configured to store a target data stream;
a hardware processor in communication with the non-transitory data storage, the hardware processor programmed to:
access the target data stream;
apply a decision tree to at least a portion of the target data stream; and
generate a predicted outcome based at least partly on the applied decision tree.

2. The decision tree processing system of claim 1, wherein the target data stream comprises an electronic prior authorization request for a prescription medication.

3. The decision tree processing system of claim 2, wherein the decision tree comprises a question set that is applied to at least a portion of the target data stream to provide a set of answers to the corresponding questions.

4. The decision tree processing system of claim 3, wherein the predicted outcome comprises a predetermination of a likely decision by a health insurance provider on the electronic prior authorization request.

5. A computer-implemented method for generating a predetermination of a decision on an electronic prior authorization (ePA) request for a prescription medication, the method comprising:
under control of an electronic prior authorization platform comprising computer hardware:
receiving an ePA request for a prescription medication for a patient from a prescriber computing device;
determining whether the patient is eligible under a payer coverage plan for the prescription medication;
for eligible patients, transmitting a payer question set related to the prescription medication to the prescriber computing device;
receiving, from the prescriber computing device and in response to the payer question set, a prescriber answer set; and
generating, based at least in part on the prescriber answer set, a predetermination of a likely decision by the payer on the ePA request.

6. The computer-implemented method of claim 5, wherein the payer question set comprises a decision tree.

7. The computer-implemented method of claim 5, wherein generating the predetermination comprises comparing the prescriber answer set with a payer answer key.

8. The computer-implemented method of claim 5, further comprising transmitting information related to the predetermination to the prescriber computing device or a computing device associated with the payer.

9. The computer-implemented method of claim 8, wherein the information is transmitted to the prescriber computing device, and the information comprises an alternative medication to an approved prescribed medication, why the ePA request was denied, or what information in the ePA can be changed to result in a different determination for the ePA request.

10. The computer-implemented method of claim 5, further comprising determining that the payer participates in a proxy program for predetermining ePA requests, and in response to the determination, transmitting the ePA request to a proxy rather than to the payer.

11. The computer-implemented method of claim 5, further comprising:
receiving patient adherence data that provides a likelihood that the patient is adhering to a treatment regimen,
wherein generating the predetermination of the likely decision by the payer on the ePA request is further based on the patient adherence data.

12. A system for generating a predetermination of a decision on an electronic prior authorization (ePA) request for a prescription medication, the system comprising:
non-transitory computer storage configured to store ePA requests and payer question sets related to the prescription medication; and
a hardware processor in communication with the non-transitory computer storage and programmed with computer-executable instructions, that when executed, cause the hardware processor to perform the method of claim 5.

13. A computer-implemented method for generating a predetermination of a decision on an electronic prior authorization (ePA) request for a prescription medication, the method comprising:
under control of an electronic prior authorization platform comprising computer hardware:
receiving an ePA request for a prescription medication for a patient from a prescriber computing device;
transmitting a payer question set related to the prescription medication to the prescriber computing device;
determining whether patient adherence data is to be obtained to provide a likelihood that the patient is adhering to a treatment regimen;
receiving, from the prescriber computing device and in response to the payer question set, a prescriber answer set;
receiving the patient adherence data; and
generating, based at least in part on the prescriber answer set and the patient adherence data, a predetermination of a likely decision by a payer on the ePA request.

14. The computer-implemented method of claim 13, wherein the payer question set comprises a decision tree.

15. The computer-implemented method of claim 13, wherein generating the predetermination comprises comparing the prescriber answer set with a payer answer key.

16. The computer-implemented method of claim 13, further comprising transmitting information related to the predetermination to the prescriber computing device or a computing device associated with the payer.

17. The computer-implemented method of claim 16, wherein the information is transmitted to the prescriber computing device, and the information comprises an alternative medication to an approved prescribed medication, why the ePA request was denied, what information in the ePA can be changed to result in a different determination for the ePA request, or what actions the patient may take to improve compliance with the treatment regimen.

18. The computer-implemented method of claim 13, further comprising determining that the payer participates in a proxy program for predetermining ePA requests, and in response to the determination, transmitting the ePA request to a proxy rather than to the payer.

19. The computer-implemented method of claim 13, wherein the patient adherence data comprises laboratory test results.

20. The computer-implemented method of claim 13, wherein the patient adherence data is received from a computing device of a third party that is not associated with the electronic prior authorization platform.

21. The computer-implemented method of claim 20, wherein the third party comprises one or more of: the prescriber, a specialist physician, a home health worker, a social worker, or a state disability determination agency.

22. The computer-implemented method of claim 13, further comprising placing the ePA request on hold until the patient adherence data is received.

23. The computer-implemented method of claim 13, further comprising analyzing the patient adherence data to determine a trend in patient adherence to the treatment regimen.

24. The computer-implemented method of claim 23, further comprising determining that the trend indicates patient non-compliance or partial compliance with the treatment regimen, and communicating a notification regarding patient non-compliance or partial compliance to a party that can assist the patient achieve compliance with the treatment regimen.

25. The computer-implemented method of claim 13, further comprising determining whether the patient is eligible under a payer coverage plan for the prescription medication.

26. A system for generating a predetermination of a decision on an electronic prior authorization (ePA) request for a prescription medication, the system comprising:
non-transitory computer storage configured to store ePA requests, payer question sets related to the prescription medication, and patient adherence data; and
a hardware processor in communication with the non-transitory computer storage and programmed with computer-executable instructions, that when executed, cause the hardware processor to perform the method of claim 13.
